(19) United States
(12) Patent Application Publication
(10) Pub. No.: US 2008/0301719 A1
(43) Pub. Date: Dec. 4, 2008

(54) Mapping Of Dynamic Link Libraries In Computing Devices

(75) Inventor: William Roberts, London (GB)

Correspondence Address: FOX ROTHSCHILD LLP, P O BOX 592, 112 NASSAU STREET, PRINCETON, NJ, 08542-0592, US

(73) Assignee: SYMBIAN SOFTWARE LIMITED, London (GB)

(21) Appl. No.: 10/595,548

(22) PCT Filed: Oct. 28, 2004
(86) PCT No.: PCT/GB2004/004554

§ 371 Date: Aug. 20, 2008

(30) Foreign Application Priority Data
Oct. 28, 2003 (GB) 0325146.9

(51) Int. Cl. G06F 9/445

(52) U.S. Cl. 719/331

(57) ABSTRACT

A remapping component is provided for facilitating a link between an executable and a function held in a new dynamic link library (DLL) in a computing device. The remapping component is provided with a relocation instruction arranged to update, upon loading, an export data table entry for the remapping component with the address location of the function in the new dynamic link library. In this way, the executable, when calling for the function at an address location in a known DLL, will automatically jump to the address location for the function in the new DLL. The additional subroutines usually associated with remapping DLLs can therefore be avoided, providing improved operation for the computing device.

The present invention relates to a method of accessing data in a computing device and, in particular to a method of accessing data held in a dynamic link library in a computing device. The present invention also relates to a computing device controlled by the method.

The term computing device as used herein is to be expansively construed to cover any form of electrical device and includes, data recording devices, such as digital still and movie cameras of any form factor, computers of any type or form, including hand held and personal computers, and communication devices of any form factor, including mobile phones, smart phones, communicators which combine communications, image recording and/or playback, and computing functionality within a single device, and other forms of wireless and wired information devices.

Most computing devices operate under the control of an operating system. The operating system can be regarded as the software that enables all the programs to be run on the computing device and can be regarded as a key component to greater operating efficiency and easier application development.

An operating system manages the hardware and software resources of the computing device in which it is installed. These resources include such things as the central processor unit (CPU), memory, and the disc space, if a disc forms part of or is used in conjunction with the computing device. As such, the operating system provides a stable, consistent way for executables, which are also known as application programs, running on the computing device to deal with the hardware resources of the device without the executable needing to know all the details of the physical resources available to the hardware. An executable/application program can be regarded as a complete, self-contained program that performs a specific function directly for the user of the device.

This task of managing the hardware and software resources is very important, because various programs and input methods compete for the attention of the CPU and demand memory, storage and input/output (I/O) resources for their respective purposes. In this capacity, the operating system ensures that each application program is provided with the necessary resources, but always has due regard to the finite physical resources available to the device.

Another task that may be performed by the operating system is that of providing a consistent application, or executable, interface. This is especially important if there is to be more than one type of computer using the operating system, or if the hardware making up the computer is ever open to change. This is particularly the case when the core operating system has several different users, such as can typically occur with computing devices in the form of wireless communications devices, such as smart phones.

With these devices it is not uncommon for various manufacturers and device suppliers to adopt certain components of a core operating system as common components, but to tailor other components of the core operating system to their respective device requirements. It is pointed out that one distinction between an application/executable program and the operating system is that applications run in ‘user mode’ (non-privileged mode), while operating systems and related utilities usually run in ‘supervisor mode’ (privileged mode). Hence, even in the smart phone example above, there are certain important components of the core operating system, known as kernel components, that are maintained exclusively in the “supervisor mode” and are only accessible, and therefore changeable, by the operating system owner or provider.

A consistent application program interface (API) allows an application program for one computing device to run on another computing device of the same type, even if the amount of memory or the quantity of storage is different between the two devices. Notwithstanding that a particular computing device is unique, the operating system can ensure that applications continue to run when hardware upgrades and updates occur, because the operating system and not the application is responsible for managing the device hardware and the distribution of its resources.

To further the efficient use of the device resources, certain functions and modules which may be common to a number of executable/application programs may be stored in the form of a library so that these functions and modules are only stored once and not replicated in each of the executable/application programs with which they are to be used. The contents of the library are therefore selectively called and linked to such programs when they are loaded or run rather than being compiled within the individual programs themselves. It follows that when this process is followed, the same block of library code can be shared between several tasks to run on the device rather than each task containing copies of the routines it uses. These functions held within the library are generally known as exported functions and a table is provided within the library containing the addresses of the exported functions. This table is generally known as the export data table.

These libraries link dynamically with the application programs as the applications are run and hence the libraries are commonly known as dynamic link libraries (DLLs). Therefore, most modern computer operating systems provide one or more DLL facilities that enable certain executable procedures and functions to be provided in the form of one or more libraries that are separate from the application programs that execute on the computing device. Typically, an application program is dynamically linked to one or more libraries at run-time, so that the application program can call one or more of the procedures and functions that are exported by the libraries. Exported procedures are commonly referred to as entry points into the libraries.

Unlike regular application programs, which are generally executed from a single entry point (usually at the beginning of the program), a DLL can be entered at any entry point. There are two main ways of identifying these entry points into a DLL. The first option is to refer to the entry points by name. The second option is to refer to the entry points by ordinal number, which describes their position in the export data table. This second option is frequently referred to as linking by ordinal. Names are potentially long in comparison to ordinal numbers and linking by name invariably involves scanning an additional table, usually held within the DLL concerned, to find the corresponding ordinal, so the names can be considered to be of secondary importance. It follows that when names are used, additional code and processing steps are required to determine the entry points into the library. Therefore, linking by name is generally considered to be more wasteful of the Read Only Memory (ROM) and Random Access Memory (RAM) resources of the computing device than linking by ordinal numbers. Ordinal linking of the entry points is therefore the preference in certain operating systems, and particularly for those for use in smart phones because this type of computing device has very restricted physical resources, and in particular the size of memory available, in comparison to those available in desktop or portable PC devices. Thus, in such devices, the efficient use of code is of paramount importance. Whilst in the examples below the present invention is described in relation to a system which uses ordinal linking, it is pointed out that the present invention is equally applicable to systems that link by name.

DLLs provide, therefore, a way by which application programs can be provided in modular format so that certain functionality can be shared, updated and reused more easily. They also help reduce memory overhead when several applications use the same functionality at the same time, because although each application is provided with a copy of the data, each can share the code representing that functionality. Furthermore, the dynamic linking enables a module within the application program to be represented by only the information needed to locate an exportable DLL function at load time or run time.

There is an increasing requirement for operating systems to provide a combination of compatibility with customisability. This is particularly the case with smart phone operating systems, such as the Symbian OS™ operating system supplied by Symbian Limited of London, England. Typically, such an operating system is supplied to smart phone handset manufacturers, who subsequently provide additional device functionality for operation under the control of the operating system. This means that an operating system of this type must maintain binary compatibility in its application program interfaces (APIs), whilst at the same time allowing derived platforms and products to add innovative and differentiating functionality to these APIs in order to customise the operating system to the requirements of the respective handset manufacturers. Binary compatibility can be defined as providing the ability to use an old executable/application program in a new environment, and have it function correctly.

However, there are difficulties associated with coordinating the DLL entry points as a system evolves from one release to the next. Hence, there is a significant need for a remapping DLL that efficiently provides the interface of an original DLL in terms of one or more DLLs which together re-implement the functionality of the original DLL. Also, a remapping DLL is a useful tool for solving the problem of providing binary compatibility for old applications, in situations where the interface of a DLL has been changed in a way that is not fully backward compatible.

It is therefore an object of the present invention to provide a method that provides such back compatibility.

According to a first aspect of the present invention there is provided a method of providing a link between an application program and a function in a dynamic link library of a computing device, the method comprising providing a remapping component arranged to provide, in response to a call by the application program to link to the function at an address location in a first dynamic link library, an address location for the function in a further dynamic link library, so as to enable the application programme to link directly to the function in the further dynamic link library.

According to a second aspect of the present invention there is provided a computing device arranged to operate in accordance with a method according to the first aspect.

According to a third aspect of the present invention there is provided computer software arranged to cause a computing device to operate in accordance with a method according to the first aspect.

Embodiments of the present invention will now be described, by way of further example only, with reference to the accompanying drawings, in which:-

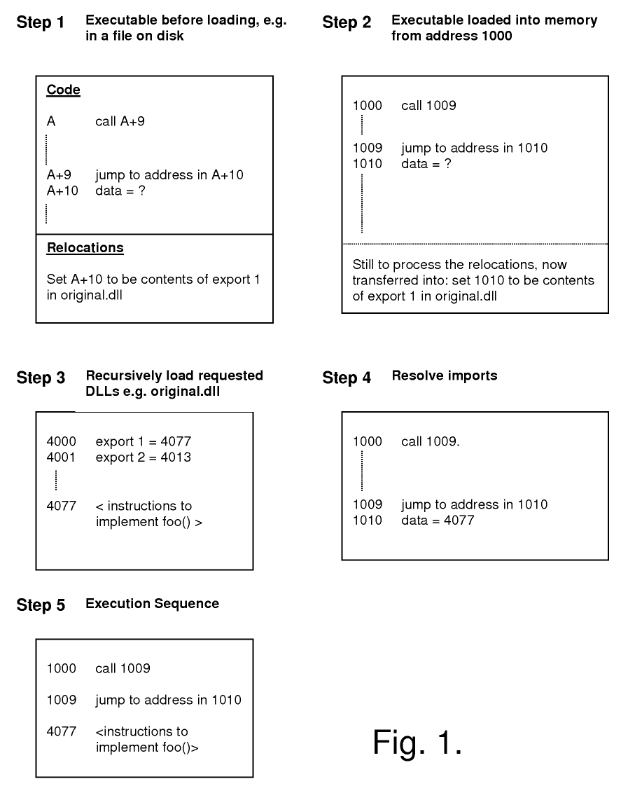

FIG. 1 illustrates how an exported function may be called from a DLL by an executable/application program;

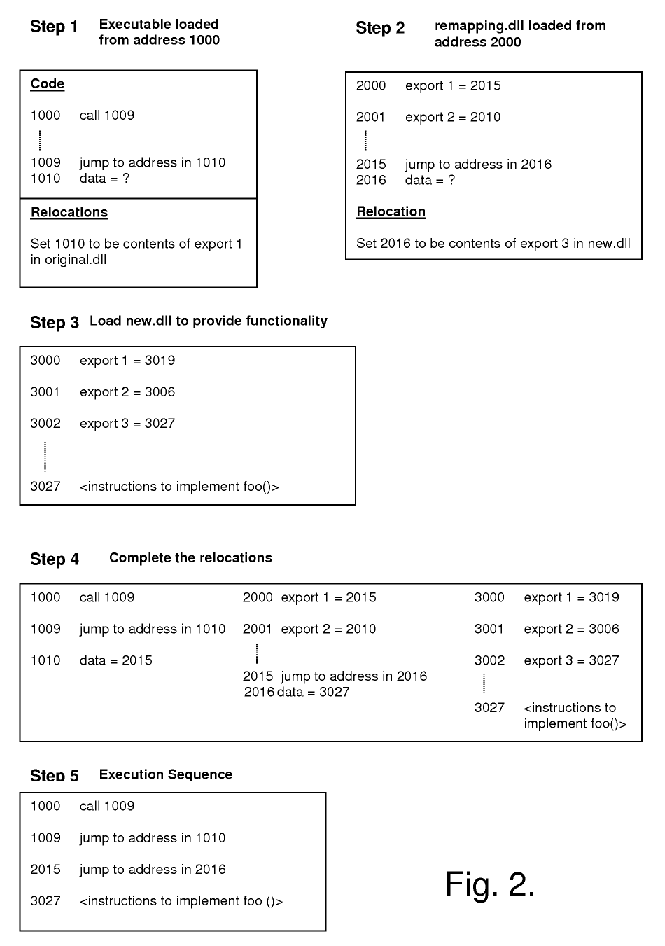

FIG. 2 illustrates how a DLL may be remapped when the interface of the DLL is re-implemented by another DLL; and

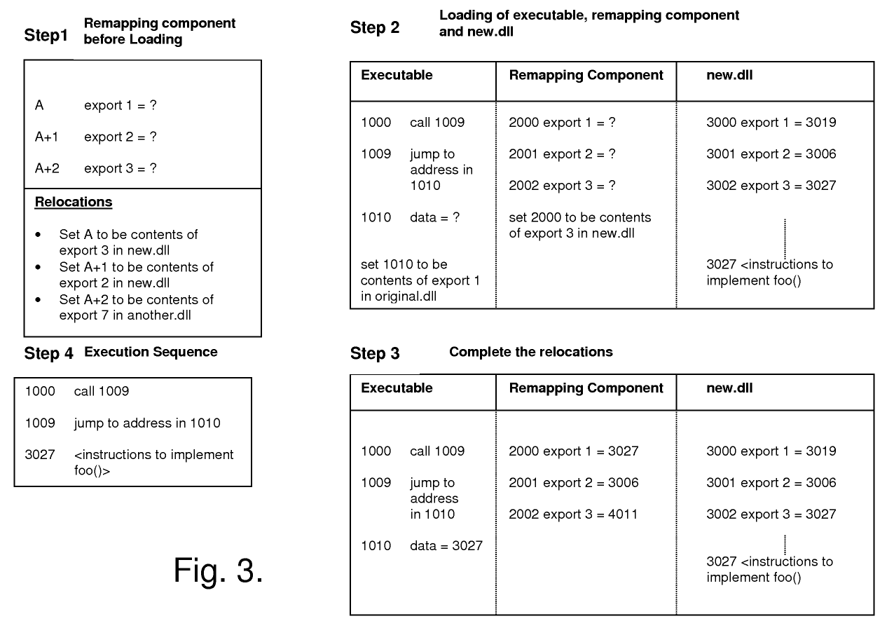

FIG. 3 illustrates a remapping component/DLL in accordance with the present invention.

Every DLL has an export data table that, as described above, lists the addresses within the DLL of exported functions. In the example illustrated in FIG. 1, the export data table commences at memory address location 4000, as shown in step 3.

If ordinal linking is used, each exported function is referred to by an ordinal number, which is the index into the export data table at which the address of the exported function is stored. Some DLLs will also store a symbolic name for each function but, for reasons as outlined previously, this takes up more memory. Hence, it is assumed in the examples of the present invention described below that linking by names is not used. However, it is stressed that the present invention would be equally applicable even if names were used to index the addresses of the DLL.

In systems where the names are omitted from the export data table, it is conventional to include a source file called a DEF file. This is used to specify the export data table for the DLL; i.e. the ordinals used within the DLL for each respective exported function.

When a DLL is created, the compilation tools usually create a companion file called an “import library” which represents the DLL in other compilations. The import library contains an “import stub” function for each exportable function in the DLL. Each stub function contains code that amounts to “jump to the address stored in location “A”, where “A” is different for each stub function. When compiling an executable that will use the DLL, the functions in the import library stand in place of the real code in the DLL.

The operating system of the computing device includes a component known as a loader. The process of making an executable/application ready for execution is called “loading”, and this is performed by the loader.

In essence, the job of the loader is to read the executable from disc into memory, load any required DLLs, and process all relocation instructions which are stored separately within the DLLs. As is known to persons familiar with this art, a relocation instruction is a coded instruction (stored separately) that describes how to modify a location within the executable in order to prepare the executable for execution at a specific address within the computing device memory space. Thus, the end result after loading is an executable image in memory that is ready to be executed, but the actual transfer of control and execution of the instructions is under the control of other parts of the operating system.

The loader must allocate memory from within the memory space of the computing device for an application program being loaded from non volatile, non-executable memory, such as a hard disc, so that the application program file can be loaded to and subsequently read from executable memory. Hence, it is a task of the operating system loader to put the appropriate value for address “A” in the stub function code of the executable, which it does at the time that the executable is made ready for execution.

Therefore, referring to FIG. 1, it can be seen from step 1 that the executable before loading contains code at an arbitrary address A which will call a subroutine at address A+9. In essence, the symbol A stands for “the first location, or address, in the executable”. The subroutine at address A+9 contains an instruction to jump to an address to be stored as data at address A+10. In other words, when the executable and all DLLs have been loaded, the address A+10 is to contain data providing the address location within a DLL of routines which do not form part of the executable but are necessary for the executable to function correctly; in this example a function foo( ). The executable also contains a relocation item and this item sets the contents of address A+10 to be the contents of export 1 in original.dll, which is the address of the instructions to implement the exported function foo( ).

The system loader allocates memory space to load the executable into executable memory within the computing device. Thus, as can be seen from step 2 of FIG. 1, the loader allocates memory space from address 1000 (the first address location for the executable and equivalent to address A) and then starts to load the executable file from disc. Therefore, after the executable has been loaded, code within the executable and loaded at address 1000 calls the subroutine at address 1009 (A+9), and the sub routine at address 1009 calls for a jump to the address which is held as data at address 1010. The relocation instruction within the executable sets the contents of address 1010 to be the contents of export 1 in original.dll. Hence, in this example it can be seen that address 1000 has been substituted for A in the import stub function code of the executable referred to above.

In summary, for an executable involving import stub functions, the loader will typically carry out the following steps for each import stub:

1. Identify the DLL associated with the import stub

2. Load that DLL (if it has not already been loaded)

3. Read the appropriate entry from the export data table of the DLL

4. Store the value for that entry into address A

To make this process efficient, each executable usually contains a “DLL reference table” which lists all of the DLLs that will be required for the executable concerned to function correctly. For each DLL, the reference table contains a list of export data table entries that are needed and the address within the executable at which each is to be stored. The precise mechanics of loading differ according to the operating system concerned and file formats used, but the detailed differences are not significant to the operation of the present invention. At the heart of all such systems, the executable being loaded is adjusted to reflect the actual address within the computing device memory space at which each required DLL has been loaded.

Hence, referring again to FIG. 1, the loader recursively loads the DLLs required for the executable to run, including original.dll which contains the instructions that implement the function foo( ). In the example shown the loader allocates memory from address location 4000 for original.dll and starts to read the file for this library from disc, commencing at address location 4000. The export data table for original.dll is loaded to address location 4000, and the first entry in this table (export 1) contains the address 4077, which is the address of the instructions to implement the function foo( ).

In this example there is no requirement to resolve the import of any function exported from a further DLL to original.dll, so the loading of originall.dll is now complete. When original.dll has been loaded, the relocation instruction in the executable “set 1010 to be contents of export 1 in originall.dll” can be completed, and thus the address stored as data at address 1010 within the executable is set to address 4077, which is the location of the instructions to implement the function foo( ) within original.dll. This is shown as step 4 in FIG. 1 and this procedure is commonly referred to in this art as “resolving imports”. In summary, the execution sequence to reach the function foo( ) to enable the executable to run is therefore as shown in step 5 of FIG. 1.

However, in the lifetime of an operating system, situations arise which make it desirable to change the interface provided by a DLL; for example to accommodate new executables for new applications to run on the computing device. But, it is also desirable to preserve compatibility with existing executables. This is particularly the case when the core operating system has several different users, each applying different applications to run under the control of that operating system, such as can frequently occur with computing devices in the form of smart phone wireless communications devices.

With these devices it is not uncommon for various device manufacturers and device suppliers to adopt certain components of a core operating system as common components, but to tailor other components of the core operating system to their respective device requirements. An example of an operating system for use in smart phones is the Symbian OS™ operating system available from Symbian Limited of London, United Kingdom. In the development of a smart phone using such a system, it is highly probable that independent changes will be made to a given DLL by both the operating system provider and one or more handset manufacturers. For example, additional APIs will be introduced by a handset manufacturer to provide individuality for the handset with consumers in the marketplace, and additional APIs will be introduced independently by the operating system provider as new functionality is incorporated into the operating system.

When this situation occurs, it becomes necessary to provide a revised DLL that supports both sets of additional APIs; i.e. those provided by the handset manufacturer and those provided by the operating system provider. However, because the entry points into the DLL are defined by ordinal and these are usually allocated on a sequential basis at the bottom of the unused ordinal number range, it is also highly probable that the handset manufacturer and the operating system provider will each have independently used the same ordinals to refer to different respective functions.

For example, assume that ordinal 77 is used for function A in the version of the DLL of the handset manufacturer, and for function B in the version of the DLL of the operating system provider. It is therefore not possible to support both sets of existing binary code sequences which link to this common ordinal using a single DLL, because ordinal 77 can only refer to one function; in this example either function A or function B, but not both. But, it is important that all DLL files accept and supply the exact data and control interface expected by the executable file when any particular ordinal is called or serious errors will develop in the execution of the executable file concerned.

Hence, a remapping component, in the form of a DLL, may be provided and this enables a re-implementation of a DLL interface in terms of a new DLL. In the example given above, a new DLL would be created that has function B (from the operating system provider) at ordinal 77 and function A (from the handset manufacturer) at ordinal 78. To support existing executables, the remapping DLL converts a call to function A, which the executable is programmed to export from ordinal 77 in the original DLL used by the handset manufacturer, into a call to the function at ordinal 78 in the new DLL. For convenience, the operating system may be modified to identify automatically the situations in which the remapping DLL would be employed. This may include modifying the DLL loading mechanism to select a remapping DLL corresponding to the DLL originally requested.

A remapping DLL may be implemented by creating a source file containing relatively straightforward (trivial) functions, each of which calls the appropriate function in the new DLL. The term ‘trivial’ is used in this context because the function can normally be reduced to a single jump instruction. These functions are exported at the correct location in the export data table of the remapping DLL by the use of a suitable DEF file, and the remapping DLL can then be created by compiling the source file and DEF file using compilation tools familiar to persons skilled in this art.

FIG. 2 is a diagram showing one form of a remapping DLL containing such trivial functions. In this example, each call to a function required by the executable has the overhead of the trivial jump function and the cost of a standard import function, as will become apparent from the following description.

In the example of FIG. 2, the instructions to implement the function foo( ) were exported at ordinal 1 in original.dll, but are now exported at ordinal 3 in a new DLL. Step 1 of FIG. 2 corresponds to the completion of step 2 of FIG. 1 in that the executable has been loaded, starting from address location 1000. Steps 2 and 3 of FIG. 2 correspond, in essence, to the completion of step 3 of FIG. 1 except that, in the example of FIG. 2, address location 2000 has been chosen at which to start the recursive loading of the DLLs. However, in this example it is necessary to load not only the remapping DLL but also the new DLL in which function foo( ) is exported at ordinal 3. In the following description the remapping DLL is referred to remapping.dll and the new DLL is referred to as new.dll. In the example shown, the loader allocates from memory address 3000 to load new.dll and the file for this library is then read from disc.

The relocations are then completed for the executable, remapping.dll (which can be regarded as a remapping version of original.dll), and new.dll in order to resolve the imported functions. Step 4 of FIG. 2 shows the result when all of the imports have been resolved by completion of the relocation instructions stored separately within each DLL. Therefore, it can be seen from FIG. 2 that the executable is again loaded from address 1000. The code at address 1000 calls the subroutine at address 1009, and this subroutine is a jump to the address stored as data at address 1010, which in this example is set from the first entry in the export data table of remapping.dll (address 2000) to be address location 2015 in remapping.dll. The subroutine at address location 2015 is a jump to the address stored as data at address location 2016. When the relocations are completed, this data is set to the contents of the third entry in the export data table of new.dll (address 3002), i.e. address 3027, which is the address of the instructions to implement function foo( ). The execution sequence for the executable to reach the required function foo( ) is therefore as summarised in step 5 of FIG. 2.

It should be noted from FIG. 2 that there is one extra jump instruction required to reach the function foo( ) in new.dll via remapping.dll, in comparison to the number of jump instructions required to reach this function in original.dll in FIG. 1. In summary, therefore, with this type of remapping DLL, when the executable is loaded, a reference to an exported function in original.dll is instead linked to an exported function in remapping.dll which in turn jumps to the correct exported function within new.dll. In other words, the executable always links to the ordinal for function foo( ) in new.dll via the redirections provided within remapping.dll and this is the reason why the additional jump step in the execution sequence cannot be avoided.

With the present invention, a more efficient way of implementing a remapping DLL is provided, and this is illustrated in FIG. 3. In the following description this more efficient remapping DLL is referred to as a remapping component. The significant feature of this remapping component is the use of relocation instructions in the component to modify the export data table of the component itself. This feature is considered to be particularly beneficial because it eliminates the execution resource overheads usually required by a remapping DLL by making the executable refer directly to the implementing (new) DLL providing the actual functionality for the executable. In other words, the import stub in the executable will refer directly to the new DLL containing the desired function, even though the remapping component has been involved in arranging that connection. Hence, the operation of the remapping component of FIG. 3 is in strict contrast to that of the remapping DLL shown in FIG. 2.

Step 1 of FIG. 3 shows the remapping component before loading. It is especially important to note from this step that the remapping component does not contain executable code. The remapping component comprises of only an export data table and relocations. The export data table has three entries, at address locations A to A+2 of the remapping component, and the data representing the relocation items in the remapping component set the contents of address location A to be the contents of export 3 in new.dll, the contents of address location A+1 to be the contents of export 2 in new.dll, and the contents of address location A+2 to be the contents of export 7 in a third DLL, referred to in this example as another.dll. It is pointed out that, in common with the example shown in FIG. 2, the instructions to implement foo( ) have been exported at ordinal 3 in new.dll.

Step 2 of FIG. 3 is, in essence, a combination of steps 1, 2 and 3 of FIG. 2, in that it shows the loading of the executable to address location 1000, and the recursive loadings of the remapping component to address location 2000, and new.dll to address location 3000.

Hence, as in FIGS. 1 and 2, the executable code at address 1000 calls the subroutine at address 1009, which is a jump to the address stored as data at address location 1010. Address location 1010 is set to be the contents of export 1 in original.dll by a relocation instruction in the executable. A relocation instruction within the remapping component sets the contents of address location 2000 within the remapping component to be the contents of export 3 in new.dll. The third entry in the export data table for new.dll (address location 3002) contains address 3027, which is the address of the instructions to implement function foo( ).

As stated above, in this remapping component, the completion of the relocations is used to modify the export data table within the remapping component itself. The remapping component does not redirect a call from the executable to an address location in original.dll to the correct address location in new.dll through the use of a subroutine within the remapping component, as would be the case with remapping.dll described with reference to FIG. 2. Hence, when the relocations are completed, the data at address location 2000 of the remapping component, which is within the export data table of the remapping component, is modified to contain address 3027, which is the address of the instructions to implement the function foo( ) within new.dll, even though that address is not within the memory allocated by the loader to contain the remapping component itself.

Hence, when the subroutine within the executable executes the instruction to jump to the address held as data at address location 1010, the executable jumps directly to address location 3027 within new.dll. The function of the remapping component is, therefore, in strict contrast to remapping.dll of FIG. 2, where it can be seen that, after the relocations are completed, the address stored as data at address location 1010 within the executable is address location 2015 of the remapping DLL, and the subroutine at this address location is an additional jump to the address stored as data at address location 2016, which is address location 3027 for the function foo( ). Thus, with the remapping component of FIG. 3, there is no need to re-route a call from the executable through the remapping DLL, as with the remapping execution sequence containing two jump steps as shown in step 5 of FIG. 2. As a result, the executable is able to link to the required function foo( ) in new.dll with only a single jump; namely the subroutine at address location 1009 jumps directly to address location 3027 in new.dll. Thus, as can be seen from step 4 in FIG. 3, the execution sequence for the executable to reach the function foo( ) in new.dll using the remapping component contains the same number of steps as required to reach the function foo( ) in original.dll. It follows, therefore, that there is no execution overhead for linking between the executable and a required function in new.dll, providing improved efficiency for operation of the computing device.

The process to load the executable, the remapping component, and new.dll, and to link between the executable and the function foo( ) held within new.dll in accordance with the method illustrated in FIG. 3, can be expressed as follows:

Load the Executable

Allocate Memory from Address 1000 and Load Executable File from Disc
1000 call A+9
1009 jump to address in A+10
1010 data?

Relocation instructions (stored separately) set A+10 to be the contents of export 1 in original.dll

Perform Relocations Enabled by the Selection of the Actual Address (Address 1000)
1000 call 1009
1009 jump to address in 1010
1010 data=?

Relocation instructions (stored separately) set 1010 to be the contents of export 1 in original.dll

RECURSIVELY LOAD REQUESTED DLLS (Including Remapping Component and new.dll)

Remapping Component

Allocate memory from address 2000, read remapping component file from disc, and perform relocations enabled by the selection of the actual address (address 2000)
2000 export1=?
2001 export2=?
2003 export3=?
Relocation instructions (stored separately)
set 2000 to be the contents of export 3 in new.dll
set 2001 to be the contents of export 2 in new.dll
set 2002 to be the contents of export 7 in another.dll
new.dll

Allocate memory from address 3000, read new.dll file from disc, and perform relocations enabled by the selection of the actual address (address 3000)
3000 export1=3019
3001 export2=3006
3002 export3=3027
3027<instructions to implement foo( )>

Complete Relocations to Resolve Imports in Remapping Component
new.dll has been fully loaded, so the relocation instruction “set 2000 to be contents of export 3 in new.dll” can be completed. Hence the data at, respectively, address locations 2000 to 2002 of the remapping component becomes
2000 export1=3027
2001 export2=3006
2002 export3=4011 (from another.dll, not shown)

Of particular interest to note is that these links to the required address locations within the required DLLs are effected as a normal part of the DLL loading process, i.e. as the relocations are completed and without reference to the full context of all the DLLs and executables being loaded. Therefore, the method does not require any additional steps other than the normal loading process, which ensures that the respective export data tables of the requested DLLs are all complete before the “Resolve imports” step is carried out.

Resolve Imports in Executable

original.dll has been fully loaded, so the relocation instruction “set 1010 to be contents of export 1 in original.dll” within the executable, can be completed.

A key thing to note is that the content of export1 (in original.dll) does not refer to any address in the remapping component. As a result of the present invention, the contents of memory address 1010 are a copy of the relevant export from new.dll, so the resulting execution sequence is
1000 call 1009
1009 jump to address in 1010
1010 data =3027

Thus, the overall effect is that the executable is linking to the function foo( ) directly in new.dll, as required, for example, by the operating system provider, even though the executable is unchanged and still refers to original.dll: the link between the executable and the required function is not being made by a redirecting subroutine in the remapping DLL, as is the case with the remapping.dll shown in FIG. 2.

Although the present invention has been described with reference to particular embodiments, it will be appreciated that modifications may be effected whilst remaining within the scope of the present invention as defined by the appended claims. For example, the remapping component has been described with reference to the provision of a link between an executable and a single function in one new DLL. However, it should be realised that the remapping component can also be arranged to update its data table in respect of a plurality of functions which may be located in a plurality of new DLLs. Furthermore, any new DLL referenced by the remapping component may itself be a remapping component referring to a further DLL, in which case the invention still provides a direct call from the executable to that further DLL, regardless of the length of the sequence of remapping DLLs involved. Hence, the “zero execution cost” provided by the method of the present invention will continue to apply if the interface to new.dll changes in the future. The end result would still be a direct jump from the executable to the appropriate address in the future provided DLL. The trivial remapping dll solution would introduce an additional overhead at every level of redirection so, for a pair of remapping DLLs, the remapping.dll would be two jumps more expensive than the remapping component of the present invention, for three remapping DLLs three jumps more expensive; and so on.

1. A method of providing a link between an application program and a function in a dynamic link library of a computing device, the method comprising providing a remapping component arranged to provide, in response to a call by the application program to link to the function at an address location in a first dynamic link library, an address location for the function in a further dynamic link library, so as to enable the application programme to link directly to the function in the further dynamic link library.

2. A method according to claim 1 wherein the address location of the function in the further dynamic link library is provided by inserting the address location into an export data table for the remapping component.

3. A method according to claim 2 comprising using a relocation instruction in the remapping component to insert the said address location into the export data table.

4. A method according to claim 1 wherein the remapping component is arranged to provide the respective address locations of a plurality of functions in a plurality of further dynamic link libraries.

5. A method according to claim 1 comprising providing a plurality of the remapping components between the first dynamic link library and the further dynamic link library.

6. A method according to claim 1 wherein the application program is arranged to link by ordinal number to the dynamic link library.

7. A method according to claim 1 wherein the application program is arranged to link by name to the dynamic link library.

8. A computing device arranged to operate in accordance with the method of claim 1.

9. Computer software arranged to cause a computing device to operate according to the method of claim 1.
